(19) United States
(12) Patent Application Publication
(10) Pub. No.: US 2003/0116742 A1
(43) Pub. Date: Jun. 26, 2003

(54) Gate valve

(76) Inventors: Robert William Anderson, Stocksfield (GB); David Michael Kay, Hartlepool (GB)

Correspondence Address: LARSON & TAYLOR, PLC, 1199 NORTH FAIRFAX STREET, SUITE 900, ALEXANDRIA, VA, 22314, US

(21) Appl. No.: 10/164,617

(22) Filed: Jun. 10, 2002

(30) Foreign Application Priority Data
Jun. 13, 2001 (GB) 0114405.4

(51) Int. Cl. F16K 3/00

(52) U.S. Cl. 251/326

(57) ABSTRACT

A gate valve comprises a body member having a bore therethrough, a gate member movable transversely of the bore between an open position permitting full flow through the bore, and a closed position preventing flow through the bore, and a stem portion mounted in the body member to be axially fixed therein but rotatable relative thereto, one end of the stem portion co-operating with the gate member whereby rotation of the stem portion results in movement of the gate member between its open and closed positions, a sleeve member secured to, to be rotatable with, the stem portion external of the body member and defining an annular gap between the stem portion and the sleeve member, and an annular skirt within said gap, the skirt being rotatably fixed but axially movable relative to the stem portion, the skirt and sleeve member threadedly engaging one another such that rotation of the sleeve member results in axial movement of the skirt relative to the sleeve member and the stem portion in a direction dependent upon the direction of rotation of the stem portion.

### BACKGROUND OF THE INVENTION

This invention relates to gate valves, and more particularly to non-rising stem gate valves.

Gate valves conventionally comprise a gate to which is attached a stem rotation of which is controlled by a handwheel attached to the stem.

In rising stem gate valves, the stem rises and falls with the gate on rotation of the handwheel, and the position of the gate—ie open, partly open or closed—is immediately apparent from the axial position of the stem.

A typical non-rising stem gate valve is illustrated in FIG. 1 and includes a handwheel 2 mounted to, to be rotatable with, a stem 4 the lower end of which is threaded and is received within a correspondingly threaded bore in a gate 6 or in a gate lift nut carrying the gate. The handwheel 2/stem 4 are axially fixed whereby, on rotation thereof, and depending upon the direction of said rotation, the gate 6 is either raised or lowered relative thereto.

Unlike rising stem gate valves, there is no external means of knowing positively whether or not a non-rising stem gate valve is open, partly open or closed, as the handwheel/stem remain in a fixed axial position. Although the handwheel is rotated in the direction of an ‘open-closed’ arrow marked thereon, and when the handwheel has been turned fully in one direction the valve should be in either the fully open or fully closed position, there are many situations where ‘testing’ the valve to define its operational stance is undesirable, and one can never be certain that the valve is fully open or fully closed because of the possibility of seizure or sticking.

U.S. Pat. No. 2,932,979 discloses a valve incorporating a pointer, which is arranged to move upwardly and downwardly on a rod on rotation of the rod to give a visual indication of the condition of the valve.

### SUMMARY OF THE INVENTION

It would be desirable to be able to provide a non-rising stem gate valve of a compact nature the condition of which can be determined visually other than by relying upon the angular position of the handwheel or the position of a pointer.

According to the present invention there is provided a gate valve comprising a body member having a bore therethrough, a gate member movable transversely of the bore between an open position permitting full flow through the bore, and a closed position preventing flow through the bore, and a stem portion mounted in the body member to be axially fixed therein but rotatable relative thereto, one end of the stem portion co-operating with the gate member whereby rotation of the stem portion results in movement of the gate member between its open and closed positions, a sleeve member secured to, to be rotatable with, the stem portion external of the body member and defining an annular gap between the stem portion and the sleeve member, and an annular skirt within said gap, the skirt being rotatably fixed but axially movable relative to the stem portion, the skirt and sleeve member threadedly engaging one another such that rotation of the sleeve member results in axial movement of the skirt relative to the sleeve member and the stem portion in a direction dependent upon the direction of rotation of the stem portion.

It will thus be appreciated that the axial position of the skirt relative to the stem portion is indicative of the position of the gate member within the valve.

In a preferred embodiment of the invention, the one end of the stem portion is externally threaded and is received within a correspondingly threaded bore in the gate member.

Preferably the skirt has a first extreme position housed within the sleeve member and associated with the open position of the gate member, and a second extreme position projecting from the sleeve member and associated with the closed position of the gate member.

Conveniently the stem portion is rotatable within an annular bearing member fixed relative to the body member, the annular gap being defined between the bearing member and the sleeve member, rotation of the skirt being prevented by co-operation of the skirt with the bearing member.

In a preferred embodiment of the invention, the external surface of the bearing member has formed therein one or more axial slots, the inner surface of the skirt being provided with one or more radial projections received within corresponding slots whereby relative rotation between the bearing member and the skirt is prevented, the axial movement of the skirt relative to the bearing member being guided by the co-operation between the slots and the projections.

Preferably a handwheel is mounted on the other end of the stem portion external of the body member to be rotatable with the stem portion.

### BRIEF DESCRIPTION OF THE DRAWINGS

FIG. 1 is a vertical section through a conventional non-rising stem gate valve;

FIGS. 2 and 3 are vertical sections through parts of a gate valve according to the invention in the open and closed positions respectively, and

FIG. 4a, b and c are, respectively, an isometric view, a plan view from above and a vertical section through an alternative skirt of a valve according to the invention.

### DESCRIPTION OF THE PREFERRED EMBODIMENTS

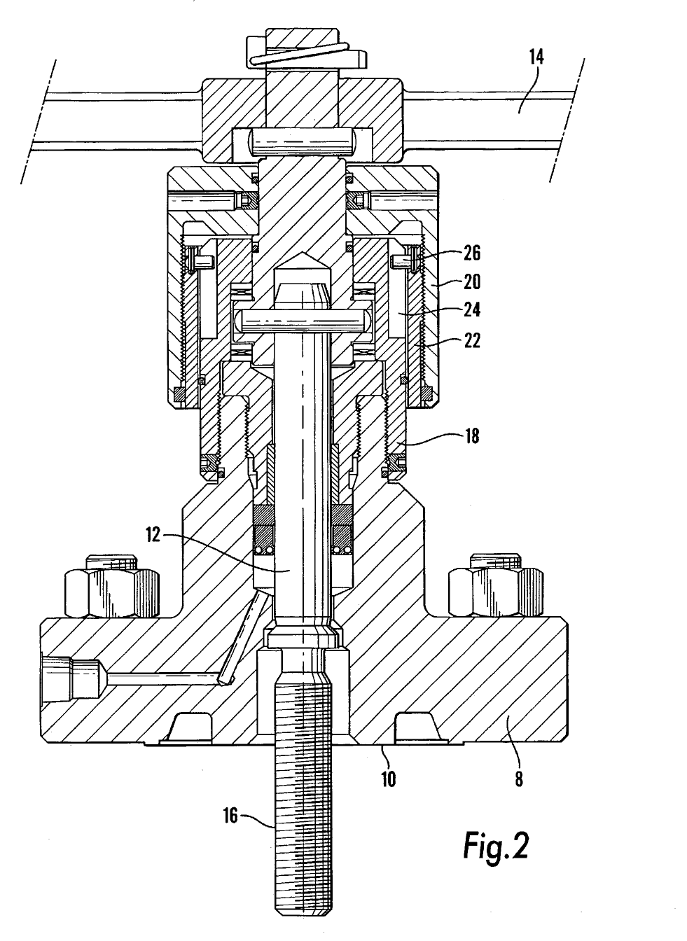

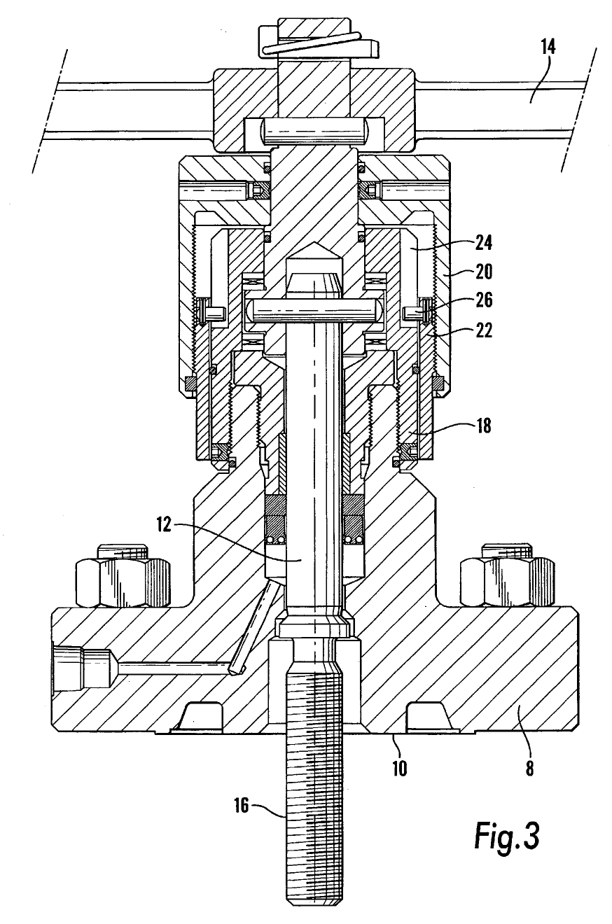

Referring to FIGS. 2 and 3 there is shown part of a gate valve according to the invention for location in a fluid flow line, the valve including a body member part of which is shown at 8 and through which is formed a bore 10.

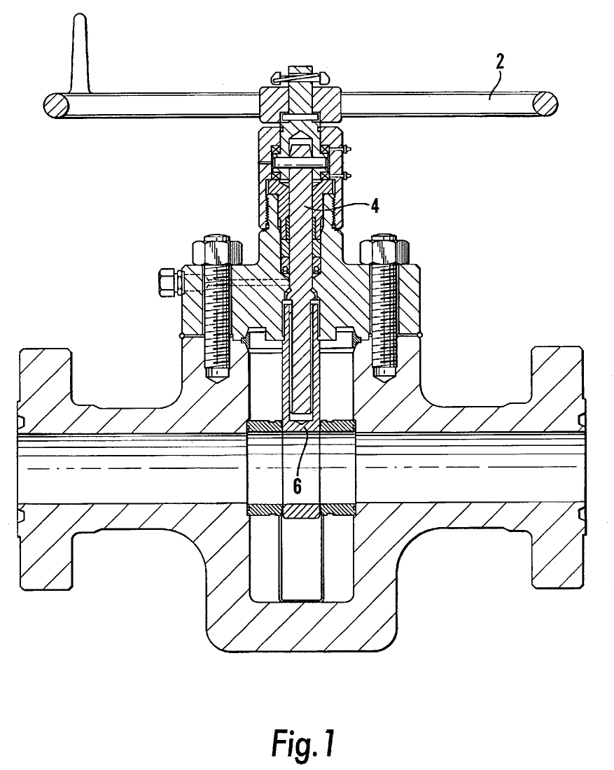

A valve stem 12 is mounted in the body member 8 to extend perpendicular to the bore 10, the stem 12 being rotatable in the body member 8 but axially fixed relative thereto. The upper end extent of the stem 12 projects from the body member 8 and has a handwheel 14 secured thereto by which the stem 12 can be rotated. The lower end extent of the stem 12 is externally threaded at 16 and carries thereon a correspondingly internally threaded gate member (not shown) in a manner similar to that shown in FIG. 1 and whereby, on rotation of the stem 12, the gate member can be raised and lowered relative to the stem 12 and within the bore 10 dependent upon the direction of rotation of the stem 12.

More particularly, a hollow cylindrical bearing cap 18 is fixed to, to project upwardly from, the body member 8, the stem 12 being rotatable within said cap 18.

Secured to the upper extent of the stem 12 to be rotatable therewith is a sleeve member 20 which surrounds the bearing cap 18 to define an annular space between the sleeve member 20 and the bearing cap 18. The lower end extent of the sleeve member 20 is internally threaded for reasons which will become apparent.

Mounted in the space between the bearing cap 18 and the sleeve member 20 is an annular skirt 22 the upper end extent of which is externally threaded to co-operate with the thread on the sleeve member 20.

The bearing cap 18 is provided with a plurality of circumferentially spaced, axially extending slots 24 in its outer wall, while the skirt 22 carries a corresponding plurality of circumferentially spaced pins 26 extending radially inwardly from the inner wall of the skirt 22 one into each of the slots 24 whereby the skirt 22 is prevented from rotating but can move axially relative to the cap 18, this axial movement being guided by the co-operation between the pins 26 and the slots 24.

Thus it will be appreciated that, on rotation of the stem 12 within the fixed bearing cap 18, the sleeve member 20 is rotated, the co-operation between the threads on the sleeve member 20 and on the skirt 22 resulting in the skirt 16 moving upwards and downwards in the annular space between the bearing cap 18 and the sleeve member 20 depending upon the direction of rotation of the stem 12.

In the fully open position of the valve shown in FIG. 2, the skirt 22 is in an uppermost position completely contained between the bearing cap 18 and the sleeve member 20. Conveniently the word ‘Open’ or some other suitable marking is engraved or otherwise marked on the exposed region of the bearing cap 18 below the skirt 22 to indicate the condition of the valve.

In the fully closed position of the valve shown in FIG. 3, the lower extent of the skirt 22 projects from the sleeve member 20 and covers the region of the bearing cap 12 below the sleeve member 20. Conveniently the word ‘Closed’ or some other suitable marking is engraved or otherwise marked on the exposed external surface of the lower extent of the skirt 22.

It will be appreciated that the axial position of the skirt 22 between the fully open and fully closed extremes is a positive and clear indication of the condition of the valve, the skirt 22 therefore acting as a position indicator for the valve.

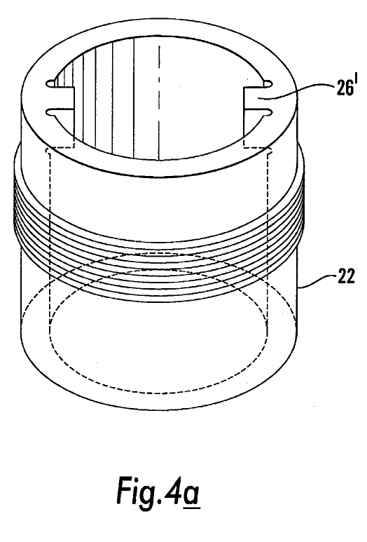

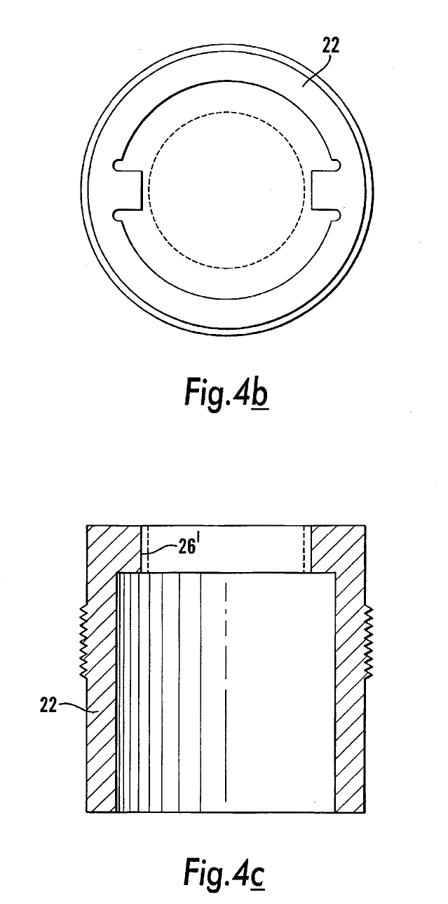

FIG. 4 illustrates an alternative arrangement for the skirt 22 in which the pins 26 have been replaced by a pair of diametrically opposed radial projections 26¹ integrally formed with the skirt 22 adjacent the upper end thereof for co-operation with the corresponding slots 24 formed in the bearing cap 18. There may of course be one or more than two such projections 26¹.

It is important in practice that the height of non-rising stem gate valves is kept as small as possible, and the pitch of the threads incorporated in such valves are chosen with this in mind. In a typical example, for a 10 cm through conduit gate valve, the gate member will have to move about 11 cms between its fully open and fully closed positions. With a typical thread of 1.6 turns per cm, it will take 18 revolutions to move the valve between the fully open and fully closed positions.

Conveniently a smaller pitch is used on the threads between the sleeve member 20 and the skirt 22 so that a significant reduction in movement is obtained. A typical pitch may be 6.4 turns per cm, giving a reduction of 4 to 1 compared with the stem/gate member thread, and a vertical movement of the skirt 22 by a distance of 2.8 cms between extreme positions thereof.

Thus there is provided a non-rising stem gate valve of a relatively compact nature incorporating a mechanical device for indicating the operational status of the valve.

What we claim and desire to protect by letters patent:

1. A gate valve comprising a body member having a bore therethrough, a gate member movable transversely of the bore between an open position permitting full flow through the bore, and a closed position preventing flow through the bore, a stem portion mounted in the body member to be axially fixed therein but rotatable relative thereto, one end of the stem portion co-operating with the gate member whereby rotation of the stem portion results in movement of the gate member between its open and closed positions, a sleeve member secured to, to be rotatable with, the stem portion external of the body member and defining an annular gap between the stem portion and the sleeve member, and an annular skirt within said gap, the skirt being rotatably fixed but axially movable relative to the stem portion, the skirt and sleeve member threadedly engaging one another such that rotation of the sleeve member results in axial movement of the skirt relative to the sleeve member and the stem portion in a direction dependent upon the direction of rotation of the stem portion.

2. A gate valve as claimed in claim 1 in which the one end of the stem portion is externally threaded and is received within a correspondingly threaded bore in the gate member.

3. A gate valve as claimed in claim 1 in which the skirt has a first extreme position housed within the sleeve member and associated with the open position of the gate member, and a second extreme position projecting from the sleeve member and associated with the closed position of the gate member.

4. A gate valve as claimed in claim 1 in which the stem portion is rotatable within an annular bearing member fixed relative to the body member, the annular gap being defined between the bearing member and the sleeve member, rotation of the skirt being prevented by co-operation of the skirt with the bearing member.

5. A gate valve as claimed in claim 4 in which the external surface of the bearing member has formed therein one or more axial slots, the inner surface of the skirt being provided with one or more radial projections received within corresponding slots whereby relative rotation between the bearing member and the skirt is prevented, the axial movement of the skirt relative to the bearing member being guided by the co-operation between the slots and the projections.

6. A gate valve as claimed in claim 1 in which a handwheel is mounted on the other end of the stem portion external of the body member to be rotatable with the stem portion.
